(19) United States
(12) Patent Application Publication
(10) Pub. No.: US 2021/0365112 A1
(43) Pub. Date: Nov. 25, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Kensuke OKAMOTO, Yokohama-shi (JP); Yuichi Kawata, Yokohama-shi (JP); Hideki Yamasaki, Yokohama-shi (JP); Yoshifumi Bando, Yokohama-shi (JP); Ryoko Saitoh, Yokohama-shi (JP); Tomoyo Nishida, Yokohama-shi (JP)

(73) Assignee: FUJIFILM Business Innovation Corp., Tokyo (JP)

(21) Appl. No.: 17/397,009

(22) Filed: Aug. 9, 2021

Related U.S. Application Data
(63) Continuation of application No. 16/162,650, filed on Oct. 17, 2018.

(30) Foreign Application Priority Data
Aug. 18, 2017 (JP) 2017-158248

(51) Int. Cl. G06F 3/01; G06F 3/0481; G06F 3/0485

(52) U.S. Cl. CPC G06F 3/013; G06F 3/0485; G06F 3/04812

(57) ABSTRACT

An information processing apparatus includes a display unit, a detection unit and a display control unit. The display unit displays a part of a character string in a display area, the character string having a length longer than a length of the display area. The detection unit detects a gaze of an operator, the gaze being fixed on a predetermined point on the display unit. The display control unit displays any other part of the character string on the display unit in a case where the gaze fixed on the predetermined point on the display unit is detected.

### CROSS-REFERENCE TO RELATED APPLICATIONS

This application is a continuation of U.S. patent application Ser. No. 16/162,650 filed Oct. 17, 2018, which is based on and claims priority under 35 USC 119 from Japanese Patent Application No. 2017-158248 filed on Aug. 18, 2017.

### BACKGROUND

### Technical Field

The present invention relates to an information processing apparatus and a non-transitory computer readable medium.

### Related Art

For example, JP-A-H08-22385 discloses a gaze-correspondence display apparatus that includes a gaze detection unit which detects a position of a gaze of an operator, and that controls a screen in a scrolled manner when a turning speed of a gaze exceeds a determined speed, or when a time period for which the gaze is fixed exceeds a predetermined time period.

Furthermore, JP-A-2002-099386 discloses a screen display control system in which an image signal from a camera is supplied to a gaze detection unit, in which the gaze detection unit detects a gazing direction from an image, in which a screen display control section detects a gaze position on a screen on a display device, in which a scroll arrow is displayed, by an arrow generation unit, on an end of the screen in a case where a gaze is fixed on the end of the screen, and in which scrolling is performed in a case where the gaze is turned to a point other than the screen after the arrow is displayed.

### SUMMARY

In some cases, only one part of a character string such as a file name is displayed in a display area. An operator selects the character string with his/her finger or a pointer and performs a scrolling operation to display other part of the character string. In some cases, it takes time to display any other part of the character string since the operator has to correctly select the character string with his/her finger or the pointer to perform a scrolling operation.

Aspect of non-limiting embodiments of the present disclosure relates to reduce the time required to display any other part of the character string in a case where only one part of a character string is displayed in a display area, when compared with a configuration in which an operator selects the character string with his/her finger or a pointer and displays any other part of the character string in a scrolling manner.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a display unit that displays a part of a character string in a display area, the character string having a length longer than a length of the display area; a detection unit that detects a gaze of an operator, the gaze being fixed on a predetermined point on the display unit; and a display control unit that displays any other part of the character string on the display unit in a case where the gaze fixed on the predetermined point on the display unit is detected.

### BRIEF DESCRIPTION OF DRAWINGS

Exemplary embodiment(s) of the present invention will be described in detail based on the following figures, wherein:

FIG. 1 is a diagram illustrating an example of a hardware configuration of an image processing apparatus according to the present exemplary embodiment;

FIG. 2 is a diagram illustrating an example of an external appearance of the image processing apparatus;

FIG. 3 is a block diagram illustrating an example of a functional configuration of a controller;

FIG. 4 is a diagram for describing an example of a configuration of a gaze detection sensor;

FIGS. 5A and 5B are diagrams, each for describing an example of the configuration of the gaze detection sensor;

FIGS. 6A to 6F are diagrams, each for describing an example of display control by a display control unit;

FIGS. 7A to 7C are diagrams, each for describing an example of the display control by the display control unit;

FIGS. 8A and 8B are diagrams, each for describing an example of a rear end part of a character string;

FIGS. 9A and 9B are diagrams, each for describing an example of processing that redisplays a pre-movement character string;

FIG. 10 is a flowchart illustrating an example of a procedure for processing that is performed in the image processing apparatus according to the present exemplary embodiment;

FIG. 11 is a diagram illustrating an example of a dedicated button;

FIG. 12A is a diagram for describing an example of a case where a character string display area is enlarged;

FIG. 12B is a diagram illustrating an example of another display area; and

FIG. 13 is a diagram illustrating an example of a hardware configuration of a computer, an application in which is possible.

### DETAILED DESCRIPTION

Exemplary embodiments of the present invention will be described in detail below with reference to the accompanying drawings.

<Hardware Configuration of an Image Processing Apparatus>

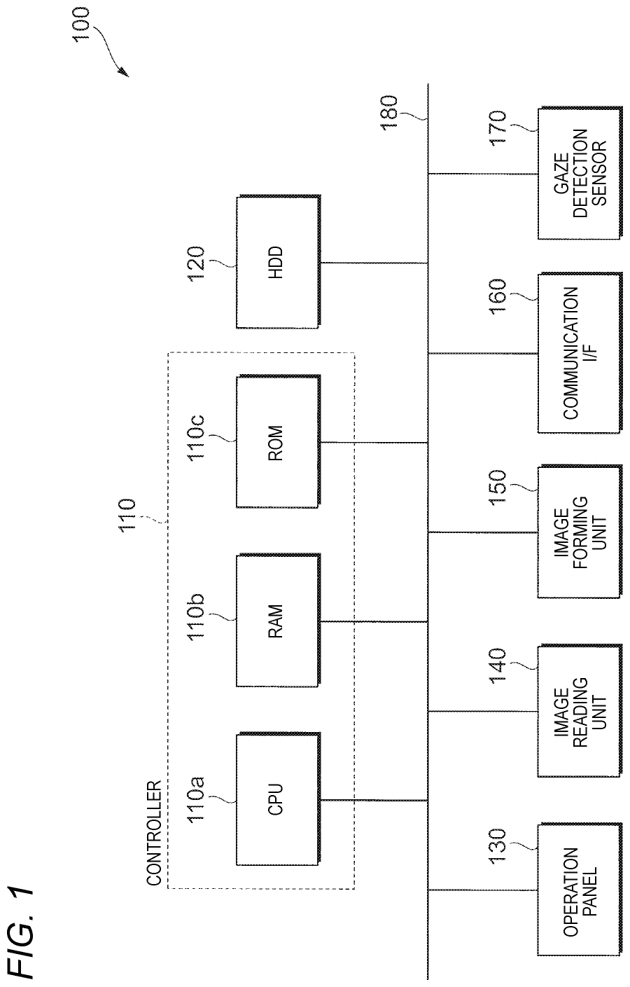

First, a hardware configuration of an image processing apparatus 100 according to the present exemplary embodiment is described. FIG. 1 is a diagram illustrating an example of a hardware configuration of the image processing apparatus 100 according to the present exemplary embodiment. The image processing apparatus 100 according to the present exemplary embodiment, for example, is a so-called multi-function machine that includes various image processing functions, such as an image reading function (a scanner function), a printing function (a printer function), a copying function (a copier function), and a facsimile function.

As illustrated, the image processing apparatus 100 according to the present exemplary embodiment includes a controller 110, a Hard Disk Driver (HDD) 120, an operation panel 130, an image reading unit 140, an image forming unit 150, a communication interface (hereinafter referred to as a “communication IF”) 160, and a gaze detection sensor 170. It is noted that these functional units are connected to a bus 180 and that performs data transmission and reception via a bus 180. In the present exemplary embodiment, the image processing apparatus 100 is used as an example of an information processing apparatus.

The controller 110 controls operation of each unit of the image processing apparatus 100. The controller 110 is configured with a Central Processing Unit (CPU) 110a, a Random Access Memory (RAM) 110b, and a Read Only Memory (ROM) 110c.

The CPU 110a loads various programs, which are stored in the ROM 110c, or the like, onto the RAM 110b for execution, and realizes each function in the image processing apparatus 100. The RAM 110b is a memory (a storage unit) that is used as a working memory or the like for the CPU 110a. The ROM 110c is a memory (a storage unit) in which various programs or the like that are executed by the CPU 110a are stored.

The HDD 120 is a storage unit in which various pieces of data are stored. For example, image data that is generated as a result of image reading by the image reading unit 140, image data that is received by a communication I/F 160 from the outside, and the like are stored in the HDD 120.

Various pieces of information are displayed on the operation panel 130 as an example of a display unit. Along with this, an operation from a user is applied to the operation panel 130. The operation panel 130 is configured from a display panel that is configured with a liquid crystal display or the like, a touch panel that is positioned on the display panel and detects a position that is touched on by the user, a physical key that is pushed down by the user, and the like. Then, for example, various screens such as a screen for operating the operation panel 130 are displayed on the display panel. Alternatively, an operation from the user, which uses the touch panel and the physical key, is applied to the display panel.

The image reading unit 140 reads an image that is formed on a recording material such as a paper sheet that is set in a document stand, and generates image information (image data) indicating the image that is read. At this point, the image reading unit 140 is, for example, a scanner, and may use a CCD method in which a reflection light that results from a light from a light source being emitted to an original document and reflecting therefrom is collected in a lens and then is received in a Charge Coupled Devices (CCD), or a Contact Image Sensor (CIS) method in which a reflection light that results from a light from a light source being successively emitted to an original document and reflecting therefrom is received in a CIS sensor.

The image forming unit 150 is a printing mechanism that forms an image on a recording material such as a paper sheet. At this point, the image forming unit 150 is, for example, a printer, and may perform electrophotographic process in which toner that is attached on a photoreceptor body is transferred to a recording material to form an image, or an ink jet method in which ink is discharged on a recording material to form an image.

The communication I/F 160 is a communication interface that performs transmission and reception of various pieces of data to and from any other apparatus through a network that is not illustrated.

The gaze detection sensor 170 detects a gaze of the user that is present in the vicinity of the image processing apparatus 100. More specifically, the gaze detection sensor 170, for example, detects the gaze of the user that is directed toward the operation panel 130 of the image processing apparatus 100. The gaze detection sensor 170 is installed at a predetermined position in the image processing apparatus 100.

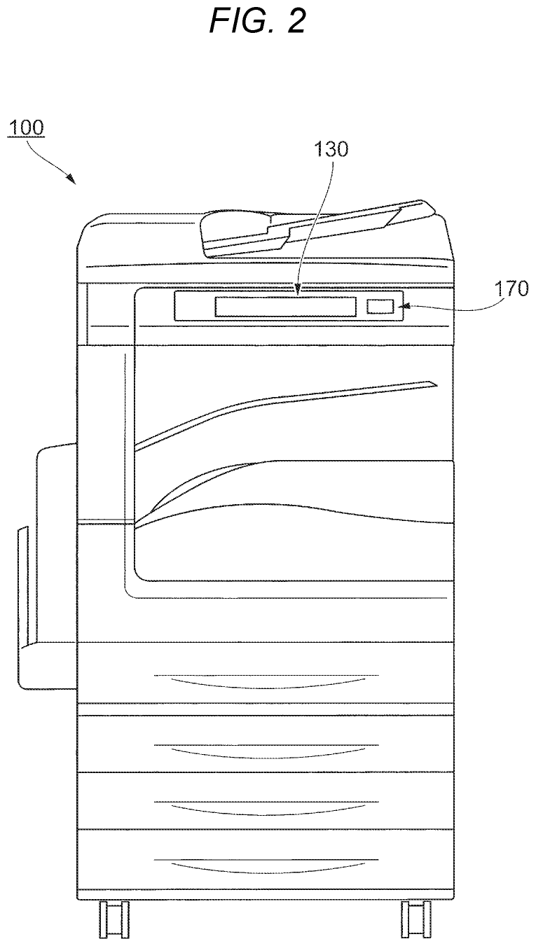

FIG. 2 is a diagram illustrating an example of an external appearance of the image processing apparatus 100. An example illustrated in FIG. 2 is an example in a case where the image processing apparatus 100 is viewed from the front side (the front surface side). The gaze detection sensor 170, for example, as illustrated in FIG. 2, is installed on the front side of the image processing apparatus 100. Additionally, the gaze detection sensor 170, for example, is installed at a position where the gaze of the user that is directed toward the operation panel 130 is detectable. More specifically, the gaze detection sensor 170, for example, is installed in the vicinity of the operation panel 130 of the image processing apparatus 100, in other words, at a position in a predetermined range away from the operation panel 130.

<Functional Configuration of the Controller>

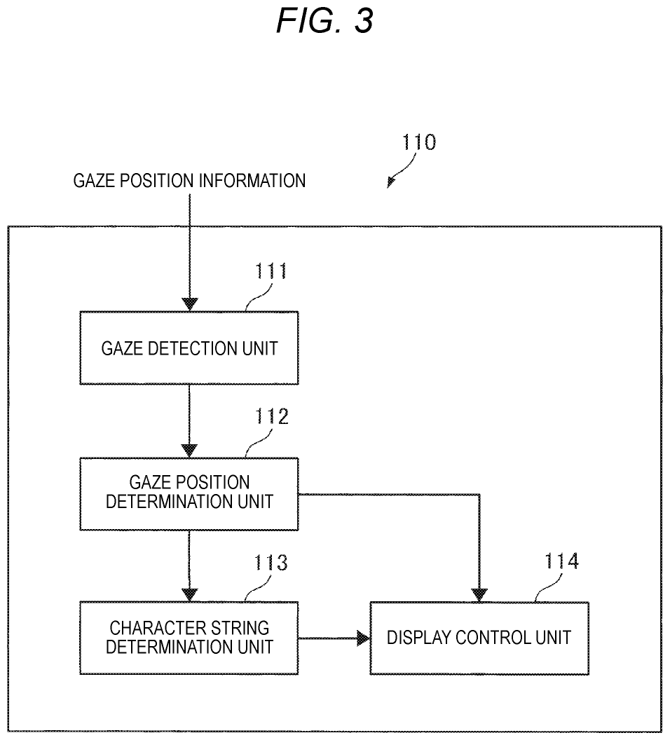

A functional configuration of the controller 110 is described. FIG. 3 is a block diagram illustrating an example of a functional configuration of the controller 110. The controller 110 has a gaze detection unit 111, a gaze position determination unit 112, a character string determination unit 113, and a display control unit 114.

The gaze detection unit 111 as an example of a detection unit acquires information (hereinafter referred to as gaze position information) on a position toward which the gaze of the user is directed, from the gaze detection sensor 170. At this point, the gaze detection unit 111, for example, periodically (for example, every 100 milliseconds) acquires the gaze position information from the gaze detection sensor 170.

For further description, considering an orthogonal coordinate system on the operation panel 130 (see FIG. 2), for example, an upper left corner of the operation panel 130 is set to be the origin 01 (0, 0), a coordinate in the horizontal direction on the operation panel 130 is set to be a X coordinate, and a coordinate in the vertical direction on the operation panel 130 is set to be a Y coordinate. Then, the gaze detection unit 111, for example, acquires information on an X coordinate and a Y coordinate of the position toward which the gaze of the user is directed, as the gaze position information.

Based on the gaze position information that is acquired by the gaze detection unit 111, the gaze position determination unit 112 as an example of a detection unit determines toward which portion of the operation panel 130 the gaze of the user is directed, that is, in which portion of the operation panel 130 a position of a destination toward which the gaze of the user is directed is present.

At this point, the gaze position determination unit 112, for example, determines whether or not the gaze of the user is directed toward an area (hereinafter referred to as a “character string display area”) that is predetermined as an area on a screen of the operation panel 130, in which a character string is to be displayed. Moreover, the gaze position determination unit 112, for example, determines toward which portion of the character string display area the gaze of the user is directed.

More specifically, the gaze position determination unit 112, for example, determines whether or not the gaze of the user is directed toward a rear end part (a part of the rear end of the character string) that is displayed in the character string display area. The rear end part of the character string is a part of the rear end of the character string that is displayed in the character string display area, and for example, is an area on which the rearmost character in the character string that is displayed in the character string display area is displayed.

It is noted that the character string display area is predetermined, for example, by an application program or the like which is being executed. Furthermore, a character is shaped using lines or points, and examples of the character include a letter, a symbol, a mark, and the like. Moreover, the character string is a set of characters, and refers to multiple characters that are linked in order. The character string may be any set of characters, and may include the character string, a file name, a name of an item that is selected by the user, a mail address, and the like as examples. Furthermore, in the present exemplary embodiment, the character string is not limited to a word, and examples of the character string also include a sentence, multiple sentences, and the like.

In a case where it is determined by the gaze position determination unit 112 that the gaze of the user is directed toward the character string display area, the character string determination unit 113 determines whether or not a state is attained where one part of the character string that is longer in length than the character string display area is displayed in the character string display area. In other words, in a case where it is determined by the gaze position determination unit 112 that the gaze of the user is directed toward the character string display area, the character string determination unit 113 determines whether or not a state is attained where all characters in the character string are displayed in the character string display area.

The display control unit 114 controls display on the operation panel 130. At this point, the display control unit 114 displays any other part of the character string on the character string display area, in a case where it is determined by the character string determination unit 113 that the state is attained where one part of the character string that is longer in length than the character string display area is displayed and where it is determined by the gaze position determination unit 112 that the gaze of the user is directed toward the rear end part of the character string that is displayed in the character string display area. Any other part of the character string is a part of the character string that is displayed in the character string display area, and for example, is a part that follows the character string that is displayed in the character string display area.

Additionally, in a case where a time period for which the gaze of the user is directed toward the rear end part of the character string on the character string display area exceeds a predetermined time period, the display control unit 114 may display any other part of the character string on the character string display area. That is, the display control unit 114 displays any other part of the character string on the character string display area, in a case where it is determined by the character string determination unit 113 that the state is attained where one part of the character string that is longer in length than the character string display area is displayed and where a time period for which the gaze of the user is directed toward the rear end part of the character string that is displayed in the character string display area exceeds a predetermined time period.

It is noted that, for example, in the orthogonal coordinate system on the operation panel 130, the display control unit 114 designates coordinates on the operation panel 130 and thus displays an image in a position having the designated coordinates, or changes coordinates of an image and thus changes a position in which the image is displayed.

Then, in the present exemplary embodiment, the display control unit 114 is used as an example of a display control unit that displays one part of the character string on a display unit.

Furthermore, each function unit that constitutes the controller 110 illustrated in FIG. 3 may be realized with corporation between software and hardware resources. Specifically, in a case where the image processing apparatus 100 is realized with a hardware configuration illustrated in FIG. 1, an OS program and an application a program, which are stored in the ROM 110c is read into the RAM 110b and then are executed by the CPU 110a. Thus, the gaze detection unit 111, the gaze position determination unit 112, the character string determination unit 113, and the display control unit 114 are realized.

<Configuration of the Gaze Detection Sensor>

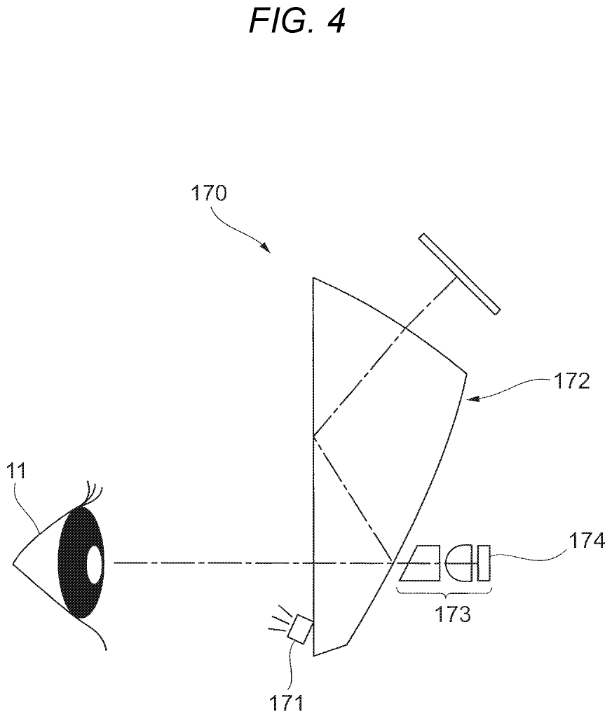

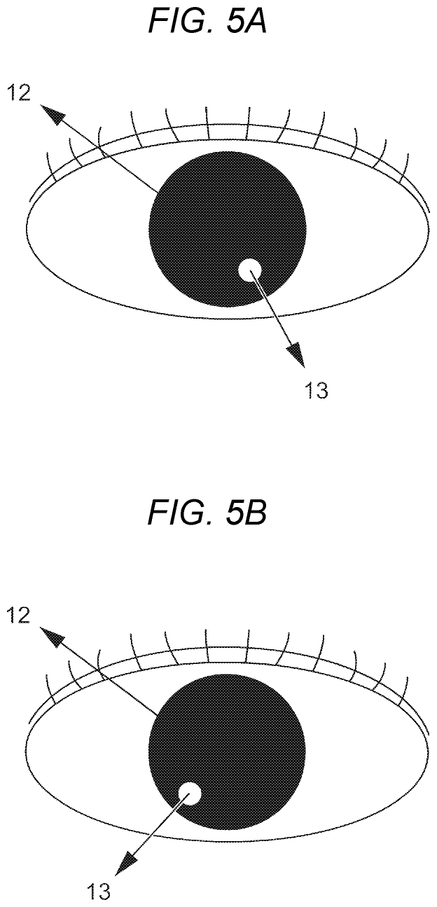

Next, a configuration of the gaze detection sensor 170 is described. FIG. 4 and FIGS. 5A and 5B are diagrams, each for describing an example of the configuration of the gaze detection sensor 170.

As illustrated in FIG. 4, the gaze detection sensor 170 has a light source 171 that illuminates an eyeball 11 of the user with an infrared light in the form of a spot, and an infrared reflection light from the eyeball 11 passes through a minute aperture diaphragm that is provided on an eyepiece lens 172 and is incident on an optical lens group 173. The optical lens group 173 image-forms the incident infrared reflection light in the form of a dot on an image capture surface of the CCD 174, and the CCD 174 converts a virtual image (a Purkinje image) due to corneal reflection, which results from the image formation on the image capture surface, into an electrical signal, and outputs the electrical signal.

The virtual image, as illustrated in FIGS. 5A and 5B, is a virtual image 13 due to the corneal reflection of the infrared light emitted from the light source 171 (see FIG. 4) from the eyeball 12, and a relative relationship between the center of the eyeball 12 and the virtual image 13 changes in proportion to a rotation angle of the eyeball 11. In the present exemplary embodiment, image processing is performed using the electrical signal representing the virtual image from the CCD 174, and the gaze (a direction of the gaze of the user or a position toward which the gaze of the user is directed) of the user is detected based on a result of the image processing.

It is noted that the detection of the gaze of the user may be performed using any other known method, without being limited to methods illustrated in FIGS. 4, 5A and 5B.

Furthermore, as the gaze detection sensor 170, for example, an eye tracker manufactured by Tobii Technology K. K. or the like may be used.

<Description of Display Control by the Display Control Unit>

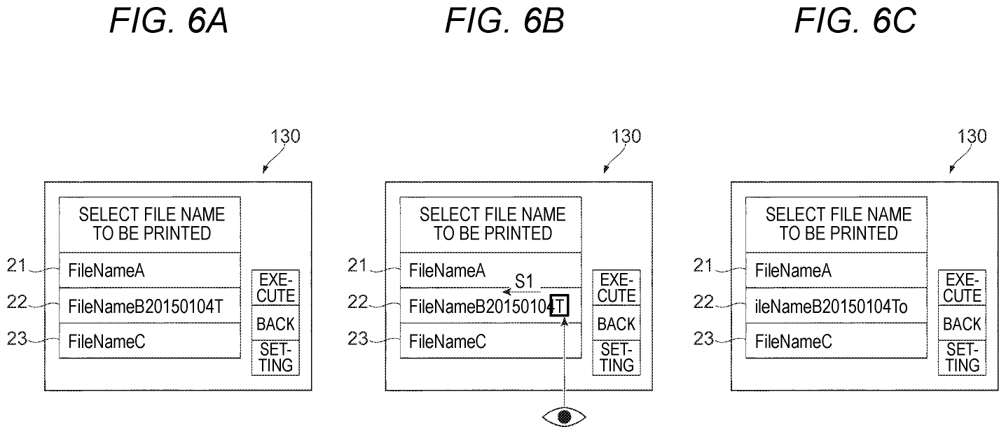

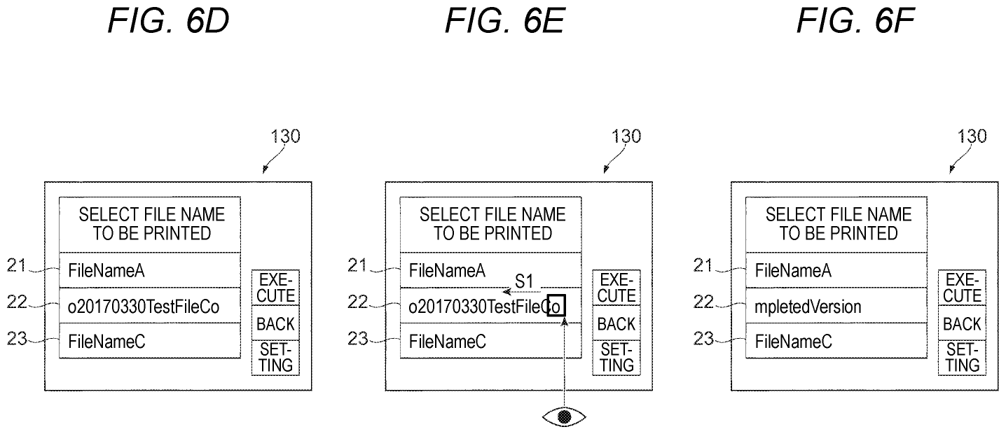

Next, display control by the display control unit 114 is described in detail. FIGS. 6A to 6F and 7A to 7C are diagrams, each for describing an example of the display control by the display control unit 114.

In an example illustrated in FIG. 6A, file names of various files are displayed on the operation panel 130. More specifically, character strings “FileNameA”, “FileNameB20150104T”, and “FileNameC” are displayed as file names of three files, respectively. “FileNameA” is a character string having a length equal to or smaller than the length of the character string display area 21, and a state is attained where all characters are displayed in the character string display area 21. In the same manner, “FileNameC” is a character string having a length equal to or smaller than the length of a character string display area 23, and a state is attained where all characters are displayed in the character string display area 23.

On the other hand, the file name “FileNameB20150104T” actually refers to the file name “FileNameB20150104To20170330TestFileCompletedVersion”. However, the character string “FileNameB20150104To20170330TestFileCompletedVersion” is a character string having a length longer than the length of a character string display area 22, and thus a state is attained where “FileNameB20150104T” that is one part of the file name is displayed.

At this point, although the gaze of the user is directed toward the character string display area 21, all characters in the file name are displayed, as “FileNameA”, in the character string display area 21. Therefore, the display in the character string display area 21 does not change. In the same manner, although the gaze of the user is directed toward the character string display area 23, the display in the character string display area 23 does not change.

On the other hand, as illustrated in FIG. 6B, in a case where the gaze of the user is directed toward the rear end part of the character string “FileNameB20150104T” that is displayed in the character string display area 22, the display control unit 114 changes the display in the character string display area 22. That is, the display control unit 114 displays any other part of the character string “FileNameB20150104TFileNameB20150104To20170330TestFileCompletedVersion”.

More specifically, the display control unit 114 moves the character string within the character string display area 22 for display. That is, the display control unit 114 displays the character string within the character string display area 22 in a scrolling manner. For further description, in an example illustrated in FIG. 6B, the display control unit 114 moves the character string in a direction (in the leftward direction in FIG. 6B) that is indicated by an arrow S1, within the character string display area 22 for display.

The character string is moved within the character string display area 22 for display, and thus, for example, as illustrated in FIG. 6C, the character string “ileNameB20150104To” is displayed. Moreover, the character string is moved, as is, for display, and, for example, as illustrated in FIG. 6D, the character string “o20170330TestFileCo” is displayed. In this example, when the character string “o20170330TestFileCo” is displayed, the character string stops.

Additionally, as illustrated in FIG. 6C, in a case where the character string “ileNameB20150104To” is displayed, with the scrolling display, the character “F” that is displayed in the front in FIG. 6B is not displayed, and a new character “o” is displayed. In this case, “o” may be regarded as being displayed as any other part of the character string. Furthermore, “o” is a part that is not displayed in the example illustrated in FIG. 6B, and may be said to be a part that follows the character string “FileNameB20150104T” that is displayed in the character string display area 22 illustrated in FIG. 6B.

Furthermore, as illustrated in FIG. 6D, in a case where the character string “o20170330TestFileCo” is displayed, the character string “o20170330TestFileCo” may be regarded as being displayed as any other part of the character string. The character string “o20170330TestFileCo” is a part that is displayed in the example illustrated in FIG. 6B. In other words, the character string “o20170330TestFileCo” may be said to be a part that follows the character string “FileNameB20150104T” that is displayed in the character string display area 22 illustrated in FIG. 6B.

Next, as illustrated in FIG. 6E, in a case where the gaze of the user is directed toward the rear end part of the character string “o20170330TestFileCo” that is displayed in the character string display area 22, in the same manner as in the example illustrated in FIG. 6B, the display control unit 114 moves the character string in the direction that is indicated by the arrow S1, within the character string display area 22 for display. As a result, as illustrated in FIG. 6F, the character string “mpletedVersion” is displayed. In this example, when the character string “mpletedVersion” is displayed, the character string stops. The character string “mpletedVersion” is displayed, all parts of the file name “FileNameB20150104TFileNameB20150104To20170330TestFileCompletedVersion” up to and including the last part thereof are displayed.

It is noted that, in the example described above, when the character string “o20170330TestFileCo” or the character string “mpletedVersion” is displayed, the scrolling display stops. At this point, the character string “o20170330TestFileCo” is a character string that has the character “o” which follows the character string “FileNameB20150104T”, as its head character, and that is so long as to be displayable on the character string display area 22. Furthermore, the character string “mpletedVersion” is a character string that has the character “m” which follows the character string “o20170330TestFileCo”, as its head character, and that is so long as to be displayable on the character string display area 22. The character string “mpletedVersion” is a character string in a case where all parts up to and including the last character “n” in the file name is displayed.

However, in the present exemplary embodiment, no limitation to the above-described configuration in which a character that follows the character string which is displayed in the character string display area is set to be a head character and thus the scrolling display is stopped is imposed. For example, a character in the middle of the character string that is displayed in the character string display area may be set to be a head character, and thus the scrolling display may be stopped. For example, in a case where the scrolling display is performed in the example illustrated in FIG. 6B, the display control unit 114 may set a character “2” in “FileNameB20150104T” to be a head character, and thus stop the scrolling display in a state where the character string “20150104To201703” is displayed in the character string display area 22.

Furthermore, in the present exemplary embodiment, in a case where the scrolling display is performed, all parts up to and including the last character of the character string may be moved for display without stopping the character string. For example, in a case where the scrolling display is performed in the example illustrated in FIG. 6B, the display control unit 114 may start to move the character string and may not end the character string until the last character “n” is displayed, as illustrated in FIG. 6F.

Moreover, in the example illustrated in each of FIGS. 6A to 6F, when the user takes a look at the character string within the character string display area 22, the user directs his/her gaze, in the rightward direction in FIGS. 6A to 6F, from the head of the character string toward the rear end part. Alternatively, in order to rediscover a character that was once viewed, it is also that the gaze is moved in the leftward-rightward direction in FIGS. 6A to 6F. On the other hand, the display control unit 114 moves the character string in the direction (that is, the leftward direction in FIGS. 6A to 6F) that is indicated by the arrow S1, within the character string display area 22. At this point, a direction of the character string that moves within the character string display area 22 may be said to be a direction opposite to (or the same direction as) a direction in which the gaze of the user is turned. That is, the display control unit 114 may be regarded as moving the character string in the direction opposite to (or the same direction as) the direction in which the gaze of the user is turned, in other words, according to the direction in which the gaze of the user is fixed.

Furthermore, in the example illustrated in FIG. 6B, characters are in a horizontally written format, and are arranged side by side in the horizontal direction in the FIG. 6B (the leftward-rightward direction). Accordingly, the display control unit 114 may be regarded as moving the character string along the direction in which the characters are arranged side by side. For further description, the display control unit 114 may also be regarded as moving the character string along a direction from a rear end part of the character string display area (or the character string that is displayed in the character string display area) to a head part, in other words, along a direction from a middle part of the character string, where interruption takes place, to the head part of the character string on the character string display area.

Moreover, in the present exemplary embodiment, the display control unit 114 may move the character string in the direction opposite to the direction in which the gaze of the user is turned. For example, in the example that is illustrated in FIG. 6B, the display control unit 114 may move the character string in the upward direction (or the downward direction in FIG. 6B) in FIG. 6B, within the character string display area 22. More specifically, for example, the character string “FileNameB20150104T” moves in the upward direction (a direction from a lower end of the character string display area 22 to an upper end) and is not displayed in the character string display area 22. On the other hand, a new character string “o20170330TestFileCo” appears from the lower end of the character string display area 22, moves in the upward direction, and is displayed in the character string display area 22.

Moreover, as an example, a case where the character string is displayed in two rows in a horizontally written format is described. FIG. 7A is a diagram illustrating an example in the case where the character string within the character string display area 22 is displayed in two rows in a horizontally written format. At this time, the display control unit 114, as illustrated in FIG. 7B, may move the character string in a direction (the leftward direction in FIG. 7B) that is indicated by an arrow S2, according to the direction in which the gaze of the user is turned.

In this case, for example, the character string “FileNameB20150104T” in the first row moves in the direction that is indicated by the arrow S2, and along this, the character string “o20170330TestFileCo” in the row line also moves in the direction that is indicated by the arrow S2. Furthermore, characters in the character string in the second line moves sequentially to the rear end part in the first row, starting from a head character, and a character that follows the character string in the second row is added to the rear end part is successively added to the rear end part of the second row.

On the other hand, the display control unit 114, as illustrated in FIG. 7C, may move the character string in a direction (the upward direction in FIG. 7C) that is indicated an arrow S3. In this case, the character string “FileNameB20150104T” moves in the direction that is indicated by the arrow S3, and thus is not displayed in the character string display area 22. Furthermore, the character string “o20170330TestFileCo” moves in the direction that is indicated by the arrow S3, and thus is displayed on the first row in the character string display area 22. Moreover, the character string “mpletedVersion” appears from the end part of the character string display area 22, moves in the upward direction, and thus is displayed on the second row in the character string display area 22.

Additionally, in the example illustrated in FIG. 7C, the gaze of the user is turned in the upward direction (or the leftward direction in FIG. 7C) in FIG. 7C, but the character string moves the upward direction in FIG. 7C. In this case, the display control unit 114 may be regarded as moving the character string along a direction that is different from the direction in which the gaze of the user is turned, for example, along a direction (the upward-downward direction in this direction) in which multiple rows are arranged side by side. It is noted that, in a case where the character string is displayed in a vertical written format, for example, the character string may be said to move along a direction (for example, the horizontal direction) in which multiple columns are arranged side by side.

Furthermore, in the examples illustrated in FIGS. 6A to 6F and 7A to 7C, the character string display area 22 is the shape of a rectangle, and an upper side (or a lower side), among four sides of the character string display area 22, is positioned along the horizontal direction in FIGS. 6A to 6F and 7A to 7C. Furthermore, a left side (or a right side), among the four sides of the character string display area 22, is positioned along the upward-downward direction in FIGS. 6A to 6F and 7A to 7C. Accordingly, for example, as illustrated in FIG. 6B, in a case where the display control unit 114 moves the character string in the direction that is indicated by the arrow S1, the display control unit 114 may be regarded as moving the character string along the upper side (or the lower side), among the four sides of the character string display area 22. Furthermore, for example, as illustrated in FIG. 7B, in a case where the display control unit 114 moves the character string in the direction that is indicated by the arrow S S, the display control unit 114 may be regarded as moving the character string along the right side (or the left side), among the four sides of the character string display area 22. In this manner, in the present exemplary embodiment, the direction in which the character string moves may also be regarded as being set to be a direction along a frame surrounding the character string display area.

Moreover, in the present exemplary embodiment, for the scrolling display of the character string, the display control unit 114 moves the character string at a predetermined speed. The predetermined speed, for example, is determined as a fixed value in the image processing apparatus 100. Furthermore, the predetermined speed may be set to be a value (or a value that is changeable from the fixed value) that is possibly set by the user.

Furthermore, the display control unit 114 may determine a moving speed of the character string according to a speed at which the gaze of the user is turned. In this case, the display control unit 114, for example, calculates a turning speed of the gaze while the gaze of the user is directed toward the character string display area. More specifically, the display control unit 114, for example, measures the time from it is determined that the gaze of the user is directed toward the character string display area to when it is determinedly that the gaze of the user is directed toward the rear end part of the character string, and a distance that the gaze moves horizontally. Then, based on the measured time and horizontal movement distance, the display control unit 114 calculates a turning speed of the gaze. At this point, the display control unit 114, for example, may move the character string at a speed that is the same as the calculated turning speed of the gaze, and may move the character string at a speed that is lower than (for example, half of) the turning speed of the gaze, or at a speed that is higher than the turning speed of the gaze.

<Description of the Rear End Part of the Character String>

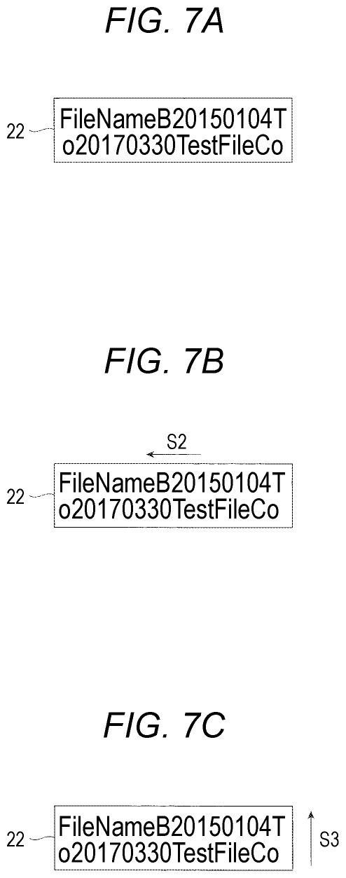

Next, the rear end part of the character string that is displayed in the character string display area is described in detail. FIGS. 8A and 8B are diagrams, each for describing an example of the rear end of the character string.

In an example illustrated in FIG. 8A, an area 24 is the rear end part of the character string, and an area where the rearmost character “T” in the character string that is displayed in the character string display area 22 is displayed is illustrated. The area 24 is an area in the vicinity of the rearmost character “T”, and is an area in a predetermined range away from the rearmost character “T”.

However, the rear end part of the character string is not limited to the area on which the rearmost character in the character string is displayed. For example, the rear end part of the character string may be an area on which characters including the rearmost character, of which the number is predetermined. In the example illustrated in FIG. 8B, an area 25 is the rear end part of the character string, and an area where three characters “04T” including the rearmost character “T” in the character string that is displayed in the character string display area 22 are displayed. The area 25 is an area in the vicinity of the character string “04T”, and is an area in a predetermined range away from the character string “04T”.

Moreover, for example, the rear end part of the character string may be determined by a ratio of characters that are displayed in the character string display area, or may be determined by a size of the character string display area. For example, in a case where ten characters are displayed in character string display area, 20 percent of the ten characters may be determined as the rear end part of the character string, and thus a display area for two characters, the first and second character from the rear end, may be set to be the rear end part of the character string. Furthermore, for example, in a case where the character string display area is 10 cm in length, an area of which length is up to 2 cm from the rear end may be the rear end part of the character string. In this manner, in the present exemplary embodiment, the rear end part of the character string may be determined according to a predetermined reference.

<Processing that Redisplays the Character String before Movement>

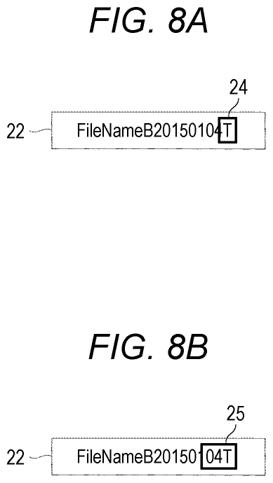

Next, processing that redisplays the character string before movement is described. The display control unit 114 detects the gaze of the user and moves the character string. Thereafter, in a case where a time period for which the gaze of the user is directed toward the head part of the character string exceeds a predetermined time period, the display control unit 114 redisplays a pre-movement character string. FIGS. 9A and 9B are diagrams, each for describing an example of the processing that redisplays the pre-movement character string.

First, in an example that is illustrated in FIG. 9A, in the same manner as in the example that is illustrated in FIG. 6A, “FileNameA”, “FileNameB20150104T”, and “FileNameC” are displayed as file names of three files, respectively. At this point, in a case where the gaze of the user is directed toward the rear end part of the character string “FileNameB20150104T” that is displayed in the character string display area 22, in the same manner as in the example in FIG. 6B, the character string moves. Then, as illustrated in FIG. 9B, the character string “o20170330TestFileCo” is displayed in the character string display area 22.

At this point, in a case where it is determined that a time period for which the gaze of the user is directed toward a head part of the character string “o20170330TestFileCo” that is displayed in the character string display area 22 exceeds a predetermined time period, the display control unit 114 moves the character string in a direction (the rightward direction in FIG. 9B) that is indicated by an arrow S4 within the character string display area 22. The character string moves, and thus, in the same manner as in FIG. 9A, the character string “FileNameB20150104T” is redisplayed.

It is noted that, as is the case with the rear end part of the character string, examples of the head part of the character string may include a part in which a head character in the character string that is displayed in the character string display area 22 is displayed, a part in which a predetermined number of characters including the head character are displayed, and the like. Furthermore, for example, in a case where the display control unit 114 moves the character string in the direction that is indicated by the arrow S4, the display control unit 114 may move the character string at a predetermined speed, and may move the character string in accordance with the turning speed of the gaze of the user.

<Procedure for Processing Performed in the Image Processing>

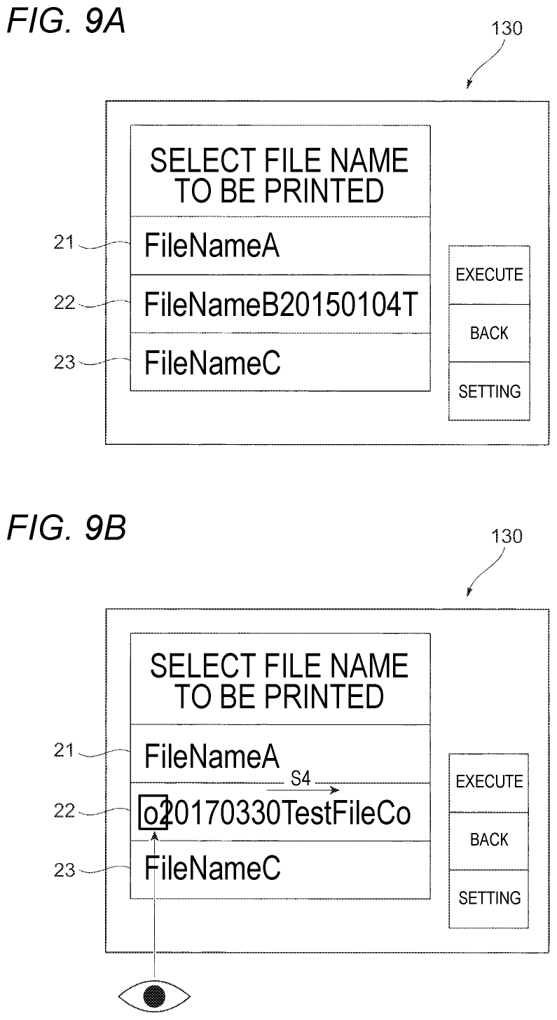

Next, a procedure for processing that is performed in the image processing apparatus 100 according to the present exemplary embodiment is described. FIG. 10 is a flowchart illustrating an example of the procedure for the processing that is performed in the image processing apparatus 100 according to the present exemplary embodiment. The image processing apparatus 100 performs processing in the flowchart illustrated in FIG. 10, for example, every fixed time (for example, every 100 milliseconds).

First, based on the gaze position information that is acquired by the gaze detection unit 111, the gaze position determination unit 112 determines whether or not the gaze of the user is directed toward the character string display area (Step 101). In a case where a result of the determination is negative (No) in Step 101, the present flow for the processing is ended. On the other hand, in a case where the result of the determination is positive (Yes) in Step 101, the character string determination unit 113 determines whether or not a state is attained where one portion of the character string that is longer in length than the character string display area is displayed in the character string display area toward which the gaze of the user is directed.

In a case where a result of the determination is negative (No) in Step 102, the present flow for the processing is ended. On the other hand, in a case where the result of the determination is positive (Yes) in Step 102, the display control unit 114 determines whether or not the scrolling display is already performed (Step 103). In a case where the result of the determination is positive (Yes) in Step 103, the display control unit 114 determined whether or not the time period for which the gaze of the user is directed toward the head part of the character string that is displayed in the character string display area exceeds the predetermined time period (Step 104).

In a case where the result of the determination is positive (Yes) in Step 104, with the scrolling display, the display control unit 114 redisplays the pre-movement character string (Step 105). Then, the present flow for the processing is ended. On the other hand, in a case where the result of the determination is negative (No) in Step 104, the gaze position determination unit 112 determines whether or not the gaze of the user is directed toward the rear end part of the character string that is displayed in the character string display area (Step 106).

In a case where the result of the determination is negative (No) in Step 106, the present flow for the processing is ended. On the other hand, in a case where the result of the determination is positive (Yes) in Step 106, the display control unit 114 moves the character string, and newly displays any other part (that is, any part that has not been displayed in the character string display area) of the character string (Step 107). Then, the present flow for the processing is ended.

As described above, in a case where the gaze of the user fixed on the rear end part of the character string that is displayed in the character string display area is detected, the image processing apparatus 100 according to the present exemplary embodiment moves the character string and thus displays any other character string in the character string display area. For example, in a case where the user selects the character string and scrolls the selected character string with his/her finger, in some cases, the user correctly selects the character string with his/her finger and performs an operation, and thus it takes time to display any other part of the character string. Furthermore, for example, in a case where the user performs a scrolling operation, it is also considered that an error in operation may occur such as an error of operating any other adjacent icon or the like. Accordingly, for example, the use of the image processing apparatus 100 according to the present exemplary embodiment may reduce the time for displaying any other part of the character string, compared with a configuration in which an operator selects the character string with his/her finger and scrolls the selected character string, and thus displays any other part of the character string. Furthermore, for example, an erroneous operation is suppressed from occurring.

<Example of Any Other Rear End Part of the Character String>

In the examples described above, in the case where the gaze of the user is directed toward the rear end part of the character string that is displayed in the character string display area, any other part of the character string is set to be displayed, but no limitation to this is imposed. In the present exemplary embodiment, in a case where the gaze of the user is directed toward any other point that is not the rear end part of the character string, the display control unit 114 may display any other part of the character string.

For example, in a case where the gaze of the user is directed toward a specific area of the character string display area, the display control unit 114 may display any other part of the character string. In addition to the rear end part of the character string, an example of the specific area may include a center part of the character string that is displayed in the character string display area.

For example, in a case where the gaze of the user is directed toward the center part of the character string that is displayed in the character string display area, although the character string starts to be moved, parts of the character string is not necessarily sequentially displayed starting from the head part, and for this reason, the user may turn his/her gaze from the center part of the character string to the rear end part and may check the character string.

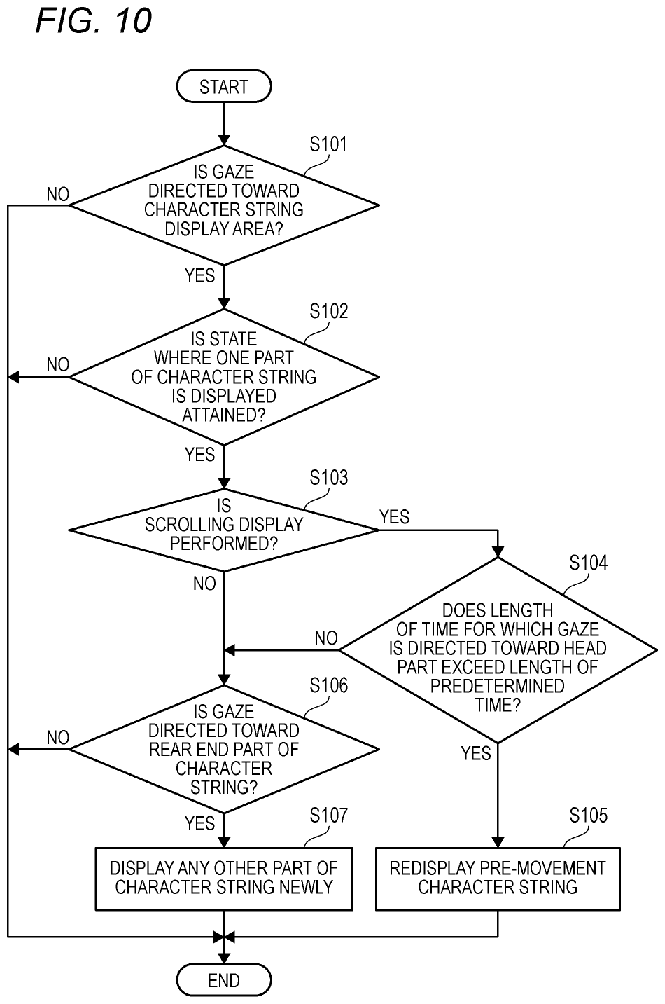

Furthermore, for example, in a case where the gaze of the user is directed toward a separate area other than the character string display area, the display control unit 114 may display any other part of the character string. An example of the separate area may include an area (a dedicated button) that is provided in a manner that corresponds to the character string display area. FIG. 11 is a diagram illustrating an example of the dedicated button. Dedicated buttons 26 to 28 illustrated in FIG. 11 correspond to the character string display areas 21 to 23, respectively. At this point, in a case where the gaze of the user is directed toward a dedicated button 27, the display control unit 114 moves the character string that is displayed in the character string display area 22, and displays any other part of the character string.

In this manner, in a case where the gaze of the user is directed toward any other point that is not the rear end part of the character string, the display control unit 114 may display any other part of the character string. Additionally, in a case where the gaze of the user is directed toward a predetermined point within the operation panel 130, the display control unit 114 may be regarded as displaying any other part of the character string. The predetermined point, as described above, for example, is a separate area other than a specific area of the character string display area, that is, the character string display area.

Furthermore, in a case where a time period for which the gaze of the user is directed toward the predetermined point within the operation panel 130 exceeds a predetermined time period, the display control unit 114 may display any other part of the character string on the character string display area. Examples of the time period for which the gaze of the user is directed toward the predetermined point may include a time period for which the gaze of the user is directed toward the rear end part of the character string, as described above. However, a time period for which the gaze of the user is directed toward the entire character string display area may be included as an additional example.

<Other Examples of Displaying the Character String>

In the example described above, the display control unit 114 moves the character string and thus displays any other part of the character string to the character string display area. However, the display control unit 114 may display any other part of the character string without moving the character string.

For example, the display control unit 114 may switch between the character strings that are displayed in the character string display area, for display. For example, in the example illustrated in FIG. 6B, in a case where the gaze of the user is directed toward the rear end part of the character string “FileNameB20150104T”, the display control unit 114 may switch from the character string “FileNameB20150104T” to the character string “o20170330TestFileCo”, without moving the character string that is displayed in the character string display area 22.

Furthermore, the display control unit 114 changes a mode for displaying the character string within the character string display area, and thus may any other part of the character string on the character string display area.

For example, the display control unit 114 changes the number of rows (or columns) for the character string, and thus may display any other part of the character string in the character string display area. For example, in the example illustrated FIG. 6B, in a case where the gaze of the user is directed toward the rear end part of the character string “FileNameB20150104T”, the display control unit 114 changes the number of rows for the character string from 1 to a predetermined number (for example, 3), and thus may display the character string “FileNameB20150104TFileNameB20150104To20170330TestFileCompletedVersion” on the character string display area 22.

Furthermore, for example, the display control unit 114 changes a size of the character, and thus may display any other part of the character string on the character string display area. For example, in the example illustrated FIG. 6B, in a case where the gaze of the user is directed toward the rear end part of the character string “FileNameB20150104T”, the display control unit 114 decreases the size of the character and thus may display the character string “FileNameB20150104TFileNameB20150104To20170330TestFileCompletedVersion” on the character string display area 22. At this point, for example, the display control unit 114 changes the character to a predetermined size, or reduces the character at a predetermined reduction rate, and thus decrease the size of the character.

It is noted that, although the number of rows for the character string is changed or the size of the character is changed, in a case where all characters in the character string are not accommodated in the character string display area, the display control unit 114 may display only one part of the character string in the character string display area. In this case, for example, the gaze of the user is redirected toward the rear end part of the character string, and thus the rear end part onwards is displayed.

Furthermore, the display control unit 114 changes the character string display area itself to display any other part of the character string in the character string display area.

For example, the display control unit 114 may enlarge the character string display area to display any other part of the character string in the character string display area. For example, as the example illustrated in FIG. 6B, in a case where the gaze of the user is directed toward the rear end part of the character string “FileNameB20150104T”, the display control unit 114 enlarges the character string display area 22 in the upward-downward direction or the horizontal direction (the leftward-rightward direction). The character string display area 22 is enlarged, and thus the area in which characters are displayable increases. As a result, characters other than the character string “FileNameB20150104T” are displayed.

It is noted that the display control unit 114 may enlarge the character string display area in any direction among the four directions, the upward direction, the downward direction, the leftward direction, and the rightward direction, and for example, may enlarge the character string display area in all the directions. At this point, the display control unit 114, for example, enlarges the character string display area by a predetermined magnification ratio, or adds an area having a predetermined length to the character string display area to enlarge the character string display area.

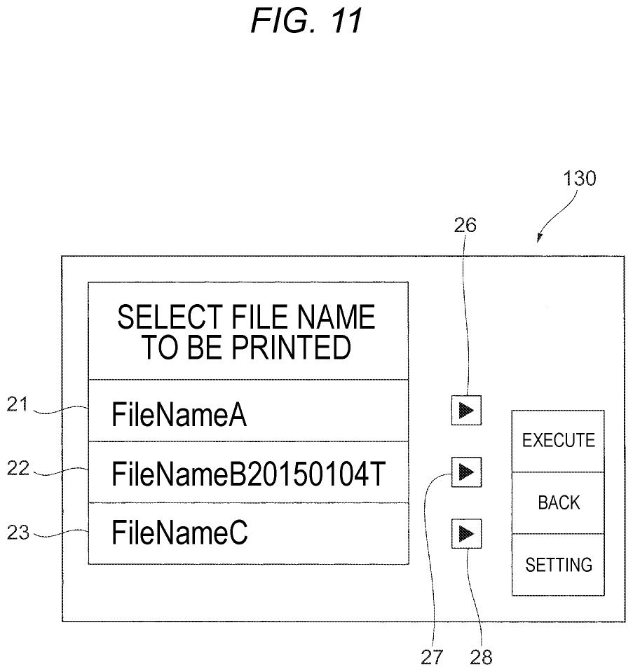

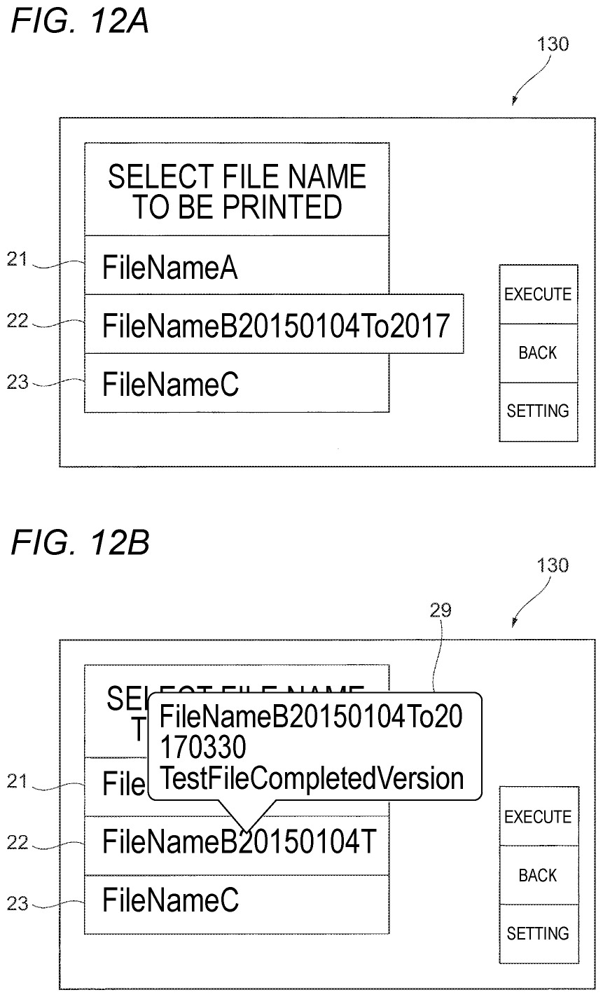

FIG. 12A is a diagram for describing an example of a case where the character string display area is enlarged. For example, in the example illustrated in FIG. 6B, in a case where the gaze of the user is directed toward the rear end part of the character string “FileNameB20150104T”, the display control unit 114, as illustrated in FIG. 12A, enlarges the character string display area 22 in the rightward direction in FIG. 12A. The character string display area 22 is enlarged in the rightward direction, and thus “FileNameB20150104To2017” is displayed as the character string. In this case, the characters “2017” are displayed, as characters that follow the character string “FileNameB20150104T”, in the area that is newly generated by enlarging the character string display area 22.

Furthermore, for example, the display control unit 114 may newly provide a separate display area other than the character string display area on which the character string is displayed, and may display any other part of the character string to the separate display area. FIG. 12B is a diagram illustrating an example of the separate display area. For example, in the example illustrated in FIG. 6B, in the case where the gaze of the user is directed toward the rear end part of the character string “FileNameB20150104T”, the display control unit 114 newly displays a display area 29 as a separate display area other than the character string display area 22. The display area 29, for example, is displayed in a pop-up format. Then, the character string “FileNameB20150104TFileNameB20150104To20170330TestFileCompletedVersion” is displayed in the display area 29.

Accordingly, instead of the entire file name, the display control unit 114 may display one part of the file name on the display area 29. In this case, the character string “FileNameB20150104T” that is displayed in the character string display area 22 may be displayed, but, at least, characters other than the characters in the character string “FileNameB20150104T” are also displayed. That is, at least, characters that are not displayed in the character string display area 22 are displayed in the display area 29. It is noted that a size of the character which is displayed in the display area 29 may be a size that is different from the size of the character that is displayed in the character string display area 22.

Furthermore, in the examples described above, in a case where one part of the character string that is longer in length than the character string display area is displayed, when the gaze of the user is detected, any other part of the character string is displayed, but the present exemplary embodiment is not limited to the examples. For example, in a case where all characters in the character string are displayed in the character string display area, when the gaze of the user is detected, the display in the character string display area may be changed. For example, in the example illustrated in FIG. 6A, in a case where the gaze of the user is directed toward the character string display area 21, the character string within the character string display area 21 may be displayed in a scrolling manner.

<Description of Applicable Computer>

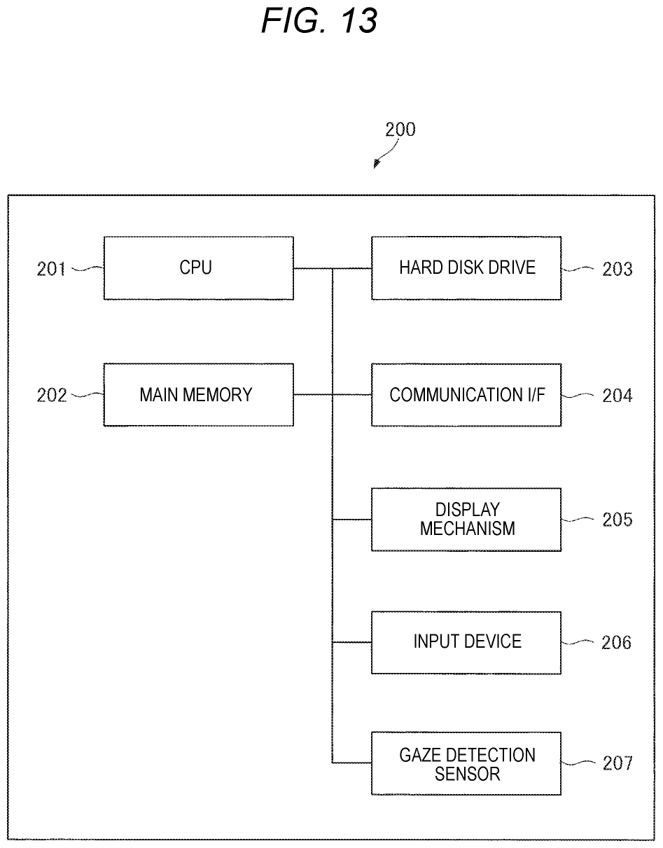

Incidentally, processing by the image processing apparatus 100 according to the exemplary embodiment may be realized, for example, in a Personal Computer (PC) such as a general-purpose computer. Accordingly, a hardware configuration of a computer 200 that is necessary to realize the processing in the computer is described. FIG. 13 is a diagram illustrating the hardware configuration of the computer 200 in which the present exemplary embodiment possibly finds application. It is noted that in the present exemplary embodiment, the computer 200 is used as an example of the information processing apparatus.

The computer 200 includes a CPU 201 that is an arithmetic operation unit, a main memory 202 that is a storage unit, and a hard disk drive (HDD) 203. At this point, the CPU 201 executes various programs such as an OS and an application. Furthermore, the main memory 202 is a storage area in which various programs, pieces of data that are used for executing the programs, and the like are stored, and a program for realizing each of the functional units illustrated in FIG. 3 are stored in the hard disk drive 203. Then, the program is loaded into the main memory 202, and the processing is performed by the CPU 201 based on the program, and thus each functional unit is realized.

Moreover, the computer 200 includes a communication interface (I/F) 204 for performing communication with the outside, a display mechanism 205 that is made up of a video memory, a display, or the like, an input device 206, such as a keyboard or a mouse, and a visual detection sensor 207 that detects the gaze of the user.

More specifically, for example, the CPU 201 reads a program that realizes the gaze detection unit 111, the gaze position determination unit 112, the character string determination unit 113, and the display control unit 114, from the hard disk device 203 into the main memory 202 and executes the program, and thus realized functions of these.

Furthermore, of course, the program that realizes the present exemplary embodiment is provided by a communication unit, and is also possibly provided in a state of being stored on a recording medium such as a CD-ROM.

It is noted that, various embodiments and modification examples are described above, but that, of course, a configuration may be employed that result from combinations of these embodiments and modification example.

For example, the display control unit 114 may not only move the character string within the character string display area, but may also newly display a separate display area other than the character string area. Furthermore, for example, the display control unit 114 may not only change the mode for displaying the character string within the character string display area, but may also change the character string display area itself.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program which, if executed, causes a computer to execute a process comprising:
controlling a display, in response to a length of a first display area being shorter than a length of an item, to display a first part of the item in the first display area and not to display a second part of the item in the first display area;
determining the item in response to a gaze being directed to a predetermined direction; and
controlling the display to display an entirety of the determined item at a time.

2. The non-transitory computer readable storage medium according to claim 1, wherein the entirety of the determined item is displayed in a different number of rows from a number of rows in which the first part of the item is displayed in the first display area.

3. The non-transitory computer readable storage medium according to claim 1, wherein the entirety of the determined item is displayed in a larger number of rows than a number of rows in which the first part of the item is displayed in the first display area.

4. The non-transitory computer readable storage medium according to claim 1, wherein the entirety of the determined item is displayed in a second display area that is different from the first display area displaying the first part of the item.

5. The non-transitory computer readable storage medium according to claim 1, wherein the entirety of the determined item is displayed in a second display area that is larger than the first display area displaying the first part of the item.

6. The non-transitory computer readable storage medium according to claim 5, wherein the second display area is an area obtained by enlarging the first display area.

7. The non-transitory computer readable storage medium according to claim 1, wherein the item is determined in response to the gaze being directed to the predetermined direction for a predetermined time.

8. The non-transitory computer readable storage medium according to claim 8, wherein the item is a character string.

9. The non-transitory computer readable storage medium according to claim 1, comprising controlling the display to display the entirety of the determined item in response to the determining the item.

10. An information processing method comprising:
controlling a display, in response to a length of a first display area being shorter than a length of an item, to display a first part of the item in the first display area and not to display a second part of the item in the first display area;
determining the item in response to a gaze being directed to a predetermined direction; and
controlling the display to display an entirety of the determined item at a time.
